(19) United States
(12) Patent Application Publication
(10) Pub. No.: US 2012/0184219 A1
(43) Pub. Date: Jul. 19, 2012

(54) METHOD AND APPARATUS FOR LEARNING OF THE PARAMETERS OF A FINGERPRINT PREDICTION MAP MODEL

(75) Inventors: Thomas Richardson, South Orange, NJ (US); Aleksandar Jovicic, Jersey City, NJ (US); Cyril Measson, Somerville, NJ (US)

(73) Assignee: QUALCOMM Incorporated, San Diego, CA (US)

(21) Appl. No.: 13/009,784

(22) Filed: Jan. 19, 2011

(51) Int. Cl. H04W 64/00

(52) U.S. Cl. 455/67.11

(57) ABSTRACT

Signal measurements are received, e.g., by a network device such as a location determination server, and a location of a mobile device to which the signal measurements correspond is determined. The measurements are also used to update parameters used to generate a signal prediction map. The signal prediction map, generated using the updated parameters, is then used for determining the position of another mobile device. In some embodiments parameter updating is performed when the location of a device is determined to a predetermined degree of certainty but not when the position of a mobile device is determined with a lower degree of certainty. Parameters used for generating prediction maps are updated, e.g., refined, based on signals collected for use in determining the location of a device without the need to conduct an updated survey and/or take signal measurements specifically for the purpose of updating prediction map parameters.

### FIELD

Various embodiments relate to mobile device position location determination, and more particularly, to methods and apparatus related to dynamically updating signal prediction maps, e.g., maps which can be used for location determination purposes.

### BACKGROUND

Positioning systems based on signal fingerprinting, e.g., RF signal matching, rely on fingerprint prediction, e.g., predicting what RF signals will be detectable at a particular location. The prediction may be represented using a map of the geographic region over which the positioning system operates. The map may contain information describing the spatial (positional) variation of the physical characteristics of the signal(s) that constitute the fingerprint, e.g., RF prediction map, or some portion thereof. In many cases the accuracy of the position estimate produced by a positioning algorithm using a fingerprint map depends upon the accuracy of the underlying fingerprinting map.

Fingerprint, e.g., RF prediction maps, may be obtained by various methods. One approach is to determine the fingerprint maps using parametric models of the propagation of the physical signal used by the positioning system. For example, in the case of RF signal based positioning, a ray-tracing algorithm may be used to compute an estimate of received signal power or signal propagation time for a given transmit location. In the indoor setting, e.g., inside a building, the propagation predicted by the ray-tracing algorithm may depend on a number of parameters, such as the RF properties of the wall/ceiling/floor materials, including reflection, refraction and diffraction effects. One benefit of using a parametric model is that the parameters, together with the building map, constitute a compact representation of the information used to estimate signal characteristics for arbitrary transmit and receive locations. If the number of potential transmit and receive locations is large, then such a model can be a more efficient means of data representation as compared to, say, directly storing the fingerprint value as a function of transmit and receive position. Efficient representation implies smaller storage requirements and/or more efficient communication of map information. Communication of map information often plays an important role in positioning systems.

One problem with the parametric model based approach to generating fingerprint maps is that the reliability of the map depends on the accuracy of the parameters used in generating the map. While the parameters may be based on an initial RF signal survey made at a point in time or over some time period, after the survey is completed RF signal sources may change and/or physical conditions may change affecting RF signal propagation at one or more locations covered by a fingerprint map. It can be costly and/or impractical to conduct RF surveys frequently.

In view of the above discussion, it should be appreciated that there is a need for methods and apparatus which can be used in updating fingerprint maps without requiring a complete RF survey to be conducted as part of the updating process.

### SUMMARY

Various embodiments are directed to methods and apparatus for updating parameters used to generate prediction maps and/or updating prediction maps based on one or more signal measurements obtained during a location determination operation. The prediction maps are sometimes referred to as fingerprint prediction maps since they can be used to identify and/or determine a location based on the signal characteristics of the location. The methods may be used, e.g., in a centralized device such as a location server in a network. However, the methods are not limited to such a centralized implementation and may also be used in decentralized systems which a centralized server is not responsible for location determinations. In some embodiments a location server is provided signal measurements, e.g., RF and/or other signal measurements, used for determining the location of a mobile device. The provided signal measurements may be measurements from a mobile device or an access point serving as a location anchor point which measures one or more signal characteristics of one or more signals to be used in a mobile device location determination operation. Exemplary physical signal characteristics which may be, and in some embodiments are, measured include, e.g., signal power, time delay, delay-spread, temperature, sound intensity, magnetic field strength, or a vector of such quantities, and the nature of the signal or signals could be electromagnetic, acoustic, etc. One, multiple, or all of the exemplary signal characteristics may, and in some embodiments are, used depending on the particular embodiment.

In some exemplary embodiments, in performing a mobile device positioning determination operation, the location server compares the one or more measured quantities, e.g., each corresponding to a different signal characteristic, against predictions inherent in the prediction map being used for location determination purposes. After determining the location of the mobile device to which the signal characteristic measurement or measurements correspond, the location server may, and in some embodiments does, use the measurements to update parameters used to generate a signal prediction map. The updated parameters may include, for example, one, multiple or all of: a wall loss parameter, a path loss parameter, a diffraction loss parameter, a reflection loss parameter, and a refraction loss parameter. Furthermore, in some embodiments, the measurements may also be used to update the statistics of one or more of the parameters such as, e.g., a mean, variance, and/or a distribution function. A signal prediction map, generated using the updated parameters and, in some embodiments the updated statistics of those parameters, is then used for determining the position of another mobile device.

In some embodiments parameter updating is performed when the location of a mobile device is determined to a predetermined degree of certainty but not when the position of a mobile device is determined with a lower degree of certainty. In this manner, parameter updating may be limited to cases where there is a high degree of certainty that the signal measurements being used to update parameters associated with a particular location actually correspond to the location for which parameters are being updated.

In this manner, parameters used for generating prediction maps are updated based on signals collected for use in determining the location of a device without the need to conduct, or use of, an updated survey and/or take signal measurements specifically for the purpose of updating prediction map parameters. An advantage of this approach is not only that the need for repeated surveys is reduced or avoided but also that locations which are frequented by devices are likely to be updated relatively frequently and remain current.

An exemplary method of operating a network device, in accordance with some embodiments, comprises: receiving signal measurements corresponding to a first mobile wireless device; determining a position of the first mobile wireless device from the received signal measurement information; updating a set of parameters used to generate a signal prediction map based on the signal measurements corresponding to the first mobile wireless device and the determined position of the first mobile wireless device; and generating a new signal prediction map based on the updated set of parameters. In various embodiments, the exemplary method further comprises determining a second position of a second mobile wireless device based on the generated new signal prediction map.

An exemplary network device, in accordance with some embodiments, comprises: at least one processor configured to: receive signal measurements corresponding to a first mobile wireless device and determine a position of the first mobile wireless device from the received signal measurement information; update a set of parameters used to generate a signal prediction map based on the signal measurements corresponding to the first mobile wireless device and the determined position of the first mobile wireless device; and generate a new signal prediction map based on the updated set of parameters. The network device further comprises memory coupled to said at least one processor. In some such embodiments, the at least one processor is further configured to determine a second position of a second mobile device based on the generated new signal prediction map.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary communications system in accordance with an exemplary embodiment.

FIG. 2 is a flowchart of an exemplary method of operating a network device, e.g., a location determination server node, in accordance with various exemplary embodiments.

FIG. 3 is a drawing of an exemplary network device in accordance with an exemplary embodiment.

FIG. 4 is an assembly of modules which can, and in some embodiments is, used in the network device illustrated in FIG. 3.

FIG. 5 is a drawing of exemplary data/information which may be included in the network device of FIG. 3 in accordance with an exemplary embodiment.

FIG. 6 is a drawing of an exemplary mapped coverage area gridmap for mobile device position determinations stored and used by a network device.

FIG. 7 shows exemplary fixed location anchor points serving as location anchor points and exemplary walls located on the gridmap of FIG. 6.

FIG. 8 is a drawing illustrating exemplary signaling and exemplary signal paths from an exemplary mobile node to the access points.

FIG. 9 illustrates exemplary signaling, attenuation sources and signal measurements corresponding to the example of FIG. 8.

FIG. 10 illustrates exemplary stored information and operations performed by a network node, e.g., location determination server node, in accordance with an exemplary embodiment.

### DETAILED DESCRIPTION

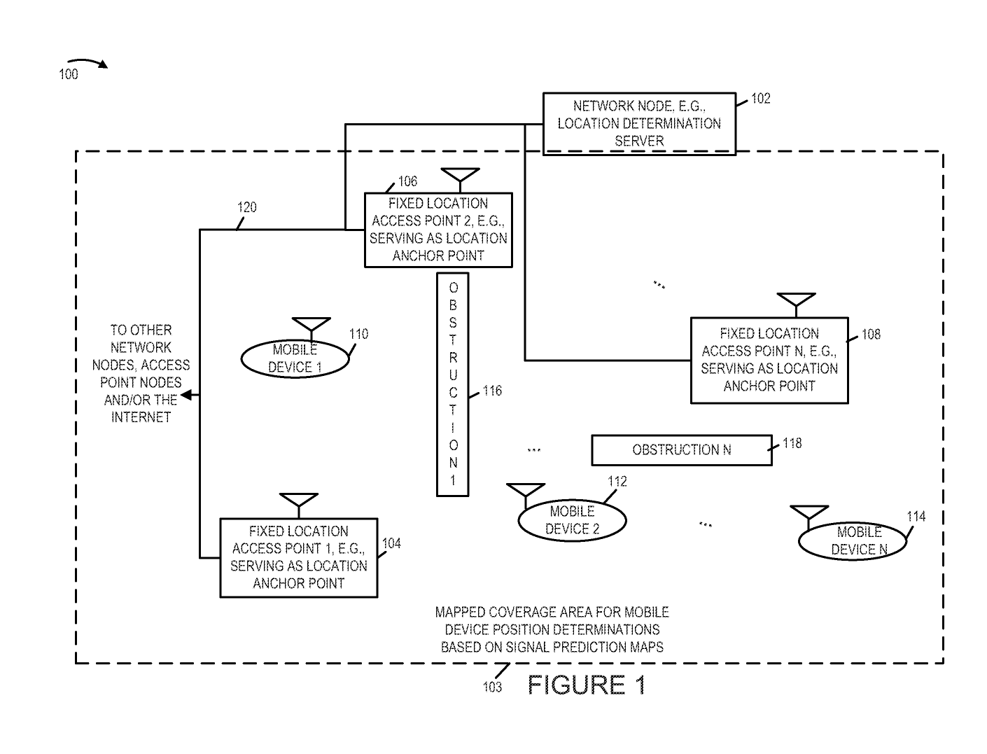

FIG. 1 is a drawing of an exemplary communications system 100 including mobile device location determination capability in accordance with various exemplary embodiments. Exemplary system 100 includes a network node 102, e.g., a location determination server node, and a plurality of fixed location access points (access point 1 104, access point 2 106, . . . , access point N 108) coupled together via a backhaul network 120. The fixed location access points (104, 106, . . . , 108) serve as location anchor points in the system. The backhaul network 120 couples the nodes (102, 104, 106, . . . , 108) to one another, to other network nodes and/or to the Internet. The network node 102, e.g., a location determination server node, has a corresponding mapped coverage area 103 for which it performs mobile device position determinations based on signal prediction maps. In some embodiments, network node 102 is located within the coverage area 103. In other embodiments, network node 102 is located outside the coverage area 103. In still other embodiments, network node 102 is located on a boundary of the coverage area 103. Within the coverage area 103, there are a plurality of obstructions (obstruction 1 116, . . . , obstruction N 118). An exemplary obstruction is a wall, which potentially affects signaling between a mobile device and a fixed location access point, e.g., causing attenuation as a signal passes through one or more walls and/or causing attenuation due to diffraction as a signal bends around a corner.

System 100 also includes a plurality of mobile wireless devices (mobile device 1 110, mobile device 2 112, . . . , mobile device N 114), which may move throughout the system. A mobile device's position may be determined, by the network node 102, e.g., location determination server, based on signal prediction map information and signal measurement information. In various embodiments, sets of parameters are used to generate a signal prediction map. The set of parameters may be, and sometimes is, updated, e.g., refined, based on measurements as the system is operated.

In one embodiment a set of parameters includes: a wall loss parameter, a path loss exponent parameter, and a diffraction parameter. The set of parameters, used in generating a signal prediction map, may be, and sometimes is, updated based on measurements of a signal or signals between a first mobile device and an access point. In some embodiments, the measured signals are peer to peer signals, communicated using a peer to peer signaling protocol. The updated set of parameters is used to generate a new signal prediction map, and the new signal prediction map is used to determine the location of a second mobile wireless device.

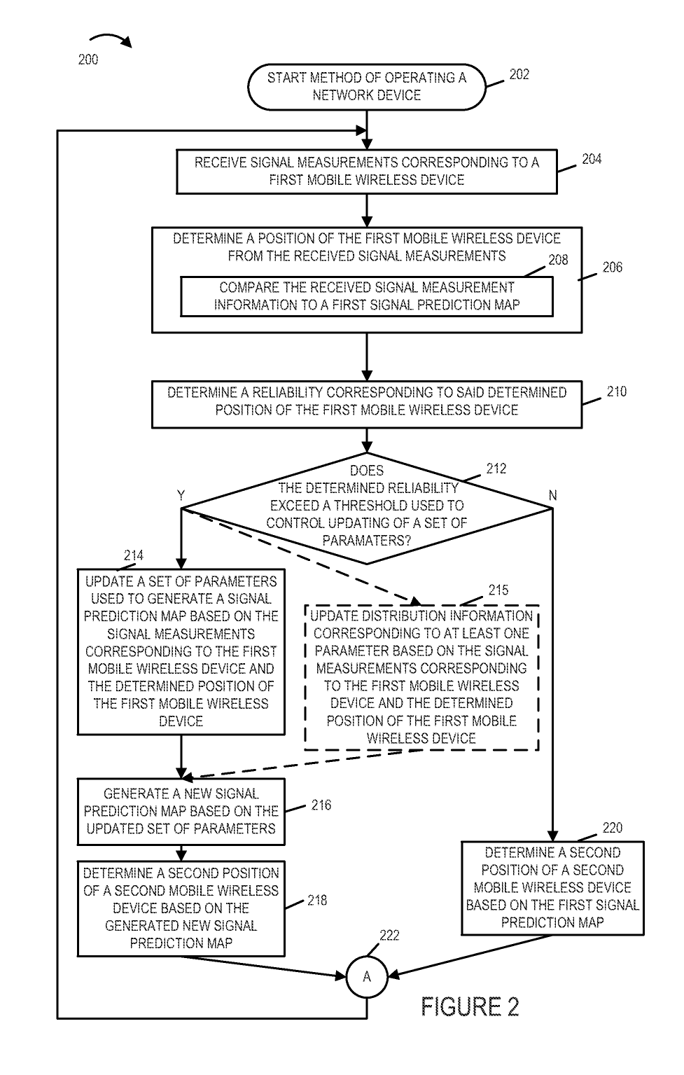

FIG. 2 is a flowchart 200 of an exemplary method of operating a network device in accordance with an exemplary embodiment. The exemplary network device is, e.g., network node 102 of FIG. 1. In various embodiments, the network device is a location determination server. Operation of the exemplary method starts in step 202, where the network device is powered on and initialized and proceeds to step 204.

In step 204 the network device receives signal measurements corresponding to a first mobile wireless device. In some embodiments, the signal measurements are measurements made by the first mobile wireless device and communicated to the network device. In some such embodiments, the measurements are RF measurements or magnetic measurements of signals from other devices. In some embodiments, the signal measurements are measurements of a signal transmitted by the first mobile wireless device which is measured by at least one access node or a second mobile wireless device. In some such embodiments, the measurements are RF measurements or magnetic measurements of signals from other devices.

In some embodiments, the measurements are electromagnetic radiation signal measurements. In some such embodiments, the signal measurements include one or more or all of: RF spectrum signal measurements, microwave spectrum signal measurements, visible light spectrum signal measurements, and IR light spectrum signal measurements. In some embodiments, the measurements are acoustic signal measurements. In some embodiments, the signal measurements include a vector of measured signals of different types. In some embodiments, the signal measurements include different signal characteristics, e.g., received signal power level, time delay, and/or delay-spread.

Operation proceeds from step 204 to step 206. In step 206 the network device determines a position of the first mobile wireless device from the received signal measurements. In some embodiments, step 206 includes step 208, in which the network device compares the received signal measurement information to a first signal prediction map. Operation proceeds from step 206 to step 210.

In step 210 the network device determines a reliability corresponding to said determined position of the first mobile wireless device. Operation proceeds from step 210 to step 212. In step 212 the network device compares the determined reliability from step 210 to a threshold used to control updating of a set of parameters. If the network device determines that the reliability exceeds the threshold then operation proceeds from step 212 to step 214, and, in some embodiments, to step 215; otherwise, operation proceeds from step 212 to step 220.

Returning to step 214, in step 214 the network device updates a set of parameters used to generate a signal prediction map based on the signal measurements corresponding to the first mobile wireless device and the determined position of the first mobile wireless device. In some embodiments, the set of parameters includes a wall loss parameter, a path loss exponent parameter, and a diffraction parameter. In some embodiments, the set of parameters include one or more or all of: a wall loss parameter, a path loss exponent parameter, a reflection loss parameter, refraction loss parameter, and diffraction loss parameter.

In step 215 the network device updates distribution information corresponding to at least one parameter in the set of parameters used to generate a signal prediction map based on the signal measurement information corresponding to the first mobile wireless device and the determined position of the first mobile wireless device. For example, in some embodiments the network device updates statistics corresponding to one or more of the parameters, such as, e.g., a mean, a variance and/or or a distribution function corresponding to a parameter. In various embodiments a set of statistical parameters corresponding to an individual parameter in the set of parameters used to generate a signal prediction map is updated. In various embodiments, different sets of statistical parameters are maintained and updated by the network device corresponding to different parameters in the set of parameters used to generate a signal prediction map. For example, a mean and a variance corresponding to the wall loss parameter may be updated; and a mean and a variance corresponding to a diffraction loss parameter may be updated. Operation proceeds from step 214, and in some embodiments, from step 215, to step 216. In step 216 the network device generates a new signal prediction map based on the updated set of parameters and, in some embodiments, the parameters' statistics. Operation proceeds from step 216 to step 218. In step 218 the network device determines a second position of a second mobile wireless device based on the generated new signal prediction map. Operation proceeds from step 218 to connecting node A 222.

Returning to step 220, in step 220 the network device determines a second position of a second mobile wireless device based on the first signal prediction map. Operation proceeds from step 220 to connecting node A 222. Operation proceeds from connecting node A 222 to step 204.

Flowchart 200 of FIG. 2 may be repeated multiple times by the network device, e.g., successively refining the set of parameters and, in some embodiments, their statistics, used to generate signal prediction maps. For different iterations of the flowchart different mobile devices may correspond to the first mobile wireless device and the second mobile wireless device.

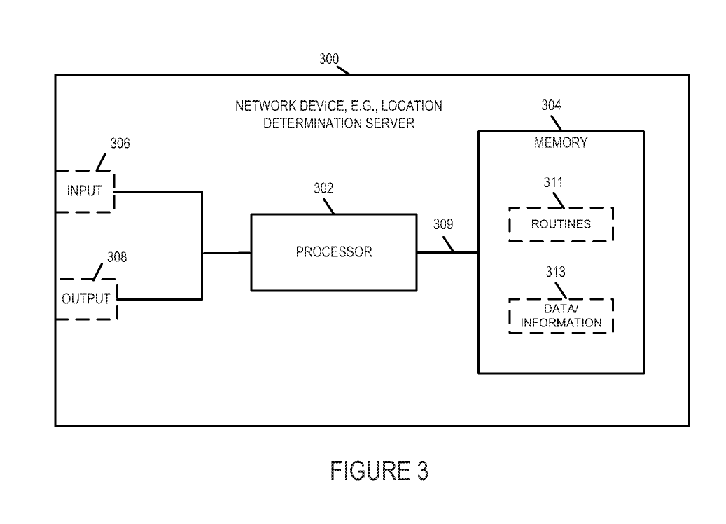

FIG. 3 is a drawing of an exemplary network device in accordance with an exemplary embodiment. Exemplary network device 300 is, e.g., network node 102, e.g., a location determination server node, of system 100 of FIG. 1. Exemplary network device 300 may, and sometimes does, implement a method in accordance with flowchart 200 of FIG. 2.

Network device 300 includes a processor 302 and memory 304 coupled together via a bus 309 over which the various elements (302, 304) may interchange data and information. Network device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 311 and data/information 313.

Processor 302 is configured to: receive signal measurements corresponding to a first mobile wireless device; determine a position of the first mobile wireless device from the received signal measurement information; update a set of parameters used to generate a signal prediction map based on the signal measurements corresponding to the first mobile wireless device and the determined position of the first mobile wireless device; and generate a new signal prediction map based on the updated set of parameters.

In various embodiments, processor 302 is further configured to: determine a second position of a second mobile wireless device based on the generated new signal prediction map.

In some embodiments, processor 302 is configured to compare the received signal measurement information to a first signal prediction map, as part of being configured to determine the position of the first mobile wireless device.

In various embodiments, processor 302 is further configured to: determine if said determined position was determined with a reliability exceeding a threshold used to control updating of said set of parameters.

In some embodiments, said signal measurements are measurements made by said first mobile wireless device and communicated to said network device 300. In some such embodiments, the signal measurements are RF measurements or magnetic measurements of signals from other devices. In some embodiments, said signal measurements are measurements of a signal transmitted by the first mobile wireless device which is measured by at least one access node or a second mobile wireless device.

In some embodiments, processor 302 is further configured to update distribution information corresponding to at least one parameter in the set of parameters used to generate a signal prediction map based on the signal measurements corresponding to the first mobile wireless device and the determined position of the first mobile wireless device.

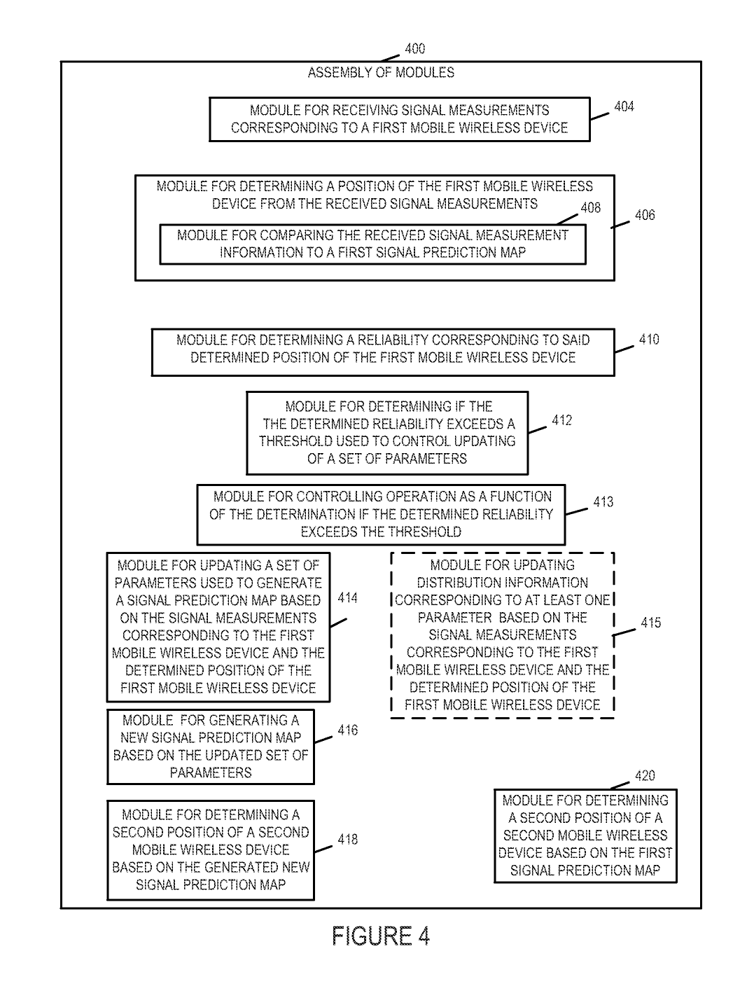

FIG. 4 is an assembly of modules 400 which can, and in some embodiments is, used in the exemplary network device 300 illustrated in FIG. 3. The modules in the assembly 400 can be implemented in hardware within the processor 302 of FIG. 3, e.g., as individual circuits. Alternatively, the modules may be implemented in software and stored in the memory 304 of network device 300 shown in FIG. 3. In some such embodiments, the assembly of modules 400 is included in routines 311 of memory 304 of device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium, e.g., a non-transitory computer readable medium, comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the network device 300 or elements therein such as the processor 302, to perform the functions of the corresponding steps illustrated and/or described in the method of flowchart 200 of FIG. 2.

Assembly of modules 400 includes a module 404 for receiving signal measurements corresponding to a first mobile wireless device, a module 406 for determining a position of the first mobile wireless device from the received signal measurements, a module 410 for determining a reliability corresponding to the determined position of the first mobile wireless device, a module 412 for determining if the determined reliability exceeds a threshold used to control updating of a set of parameters, a module 413 for controlling operation as a function of the determination if the determined reliability exceeds the threshold, a module 414 for updating a set of parameters used to generate a signal prediction map based on signal measurements corresponding to the first mobile wireless device and the determined position of the first mobile wireless device, a module 416 for generating a new signal prediction map based on the updated set of parameters, a module 418 for determining a second position of a second mobile wireless device based on the generated new signal prediction map, and a module 420 for determining a second position of a second mobile wireless device based on the first signal prediction map.

Module 406 includes a module 408 for comparing the received signal measurement information to a first signal prediction map. In various embodiments, module 413 controls operation such that modules 414, 416 and 418 are operated in response to a determination that the determined reliability exceeds the threshold used to control updating of the set of parameters; and module 413 controls operation such that module 420 is operated in response to a determination the determined reliability does not exceed the threshold.

In some embodiments, assembly of modules 400 includes a module 415 for updating distribution information corresponding to at least one parameter in the set of parameters used to generate a signal prediction map based on the signal measurements corresponding to the first mobile wireless device and the determined position of the first mobile wireless device.

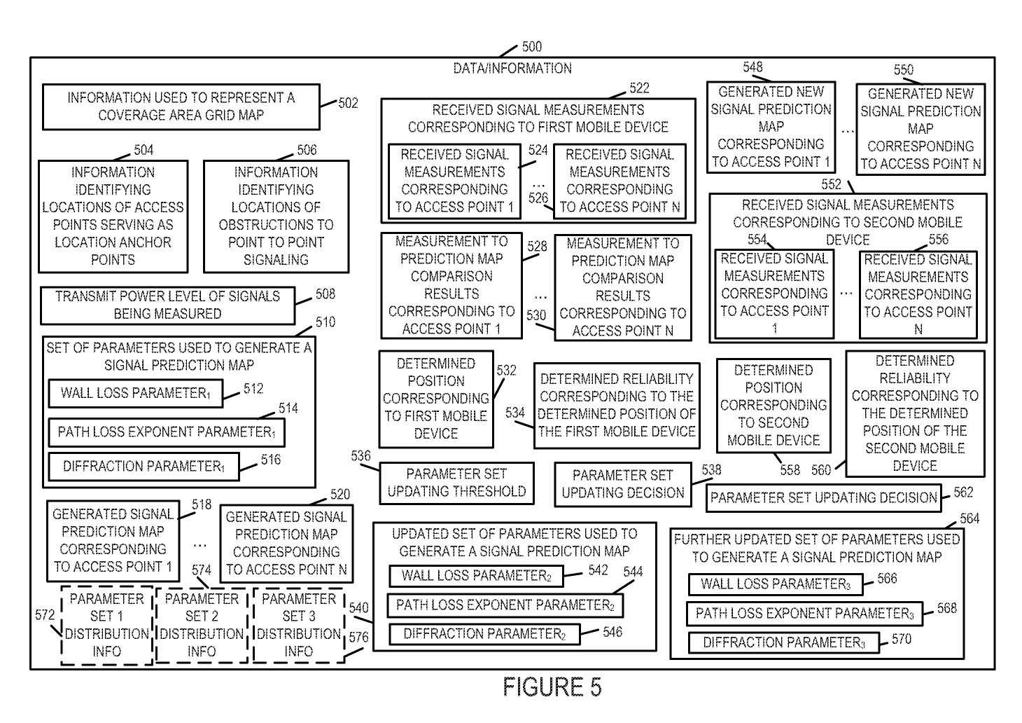

FIG. 5 is a drawing of data/information 500 in accordance with an exemplary embodiment. Data/information 500 is, e.g., data information 313 of network device 300 of FIG. 3. Data/information 500 includes information used to represent a coverage area grid map 502, information identifying locations of access points serving as location anchor points 504, information identifying locations of obstructions to point to point signaling 506, information specifying or identifying or used to determine transmit power levels of signals being measured 508, a set of parameters used to generate a signal prediction map 510, and generated signal prediction maps corresponding to each of a plurality of access points (generated signal prediction map corresponding to access point 1 518, . . . , generated signal prediction map corresponding to access point N 520). The exemplary set of parameters used to generate a signal predictions map 510 includes wall loss parameter₁ 512, path loss exponent parameter₁ 514 and diffraction parameter₁ 516.

Data/information 500 further includes received signal measurements corresponding to a first mobile device 522 including received signal measurements corresponding to a plurality of access points (received signal measurements corresponding to access point 1 524, . . . , received signal measurements corresponding to access point N 526). Data/information 500 further includes measurement to prediction map comparison results corresponding to a plurality of access points (measurement to prediction map comparison results corresponding to access point 1 528, . . . , measurement to prediction map comparison results corresponding to access point N 530).

Data/information 500 further includes a determined position corresponding to the first mobile device 532, a determined reliability corresponding to the determined position of the first mobile device 534, a parameter set updating threshold 536, a parameter set updating decision 538, and an updated set of parameters used to generate a signal prediction map 540. The exemplary updated set of parameters used to generate a signal predictions map 540 includes wall loss parameter₂ 542, path loss exponent parameter₂ 544 and diffraction parameter₂ 546.

Data/information 500 further includes generated new signal prediction maps corresponding to each of a plurality of access points (generated new signal prediction map corresponding to access point 1 548, . . . , generated new signal prediction map corresponding to access point N 550), and received signal measurements corresponding to a second mobile device 552 (received signal measurements corresponding to access point 1 554, . . . , received signal measurements corresponding to access point N 556), a determined position corresponding to the second mobile device 558, a determined reliability corresponding to the determined position of the second mobile device 560, a parameter set updating decision 562, and a further updated set of parameters used to generate a signal prediction map 564. Further updated set of parameters used to generate a signal prediction map 564 includes wall loss parameter₃ 566, path loss exponent parameter₃ 568, and diffraction parameter₃ 570.

Generated signal prediction map corresponding to access point 1 518 is generated based on information 502, information included in information 504 corresponding to access point 1, information 506, information 508 and information 510. Generated signal prediction map corresponding to access point N 520 is generated based on information 502, information included in information 504 corresponding to access point N, information 506, information 508 and information 510.

Received signal measurements 522 are received by module 404. Determined position 532 is determined by module 406. Determined reliability 534 is determined by module 410. Comparison results (528, . . . , 530) are outputs of module 408. Threshold 536 is used by module 412 and parameter set updating decision 538 is an output of module 412. Updated set of parameters 540 is an output of module 414 and is an update of set of parameters 510. Generated new signal prediction maps (548, . . . , 550) are generated by module 416 based on updated set of parameters 540. Determined position corresponding to second mobile device 558 is an output of module 418.

Generated new signal prediction map corresponding to access point 1 548 is generated based on information 502, information included in information 504 corresponding to access point 1, information 506, information 508 and information 540. Generated new signal prediction map corresponding to access point N 550 is generated based on information 502, information included in information 504 corresponding to access point N, information 506, information 508 and information 540.

In some embodiments, data/information 500 includes: parameter set 1 distribution information 572, parameter set 2 distribution information 574 and parameter set 3 distribution information 576. Parameter set 2 distribution information 574 is an update of parameter set 1 distribution 572 information generated by module 415. Parameter set 3 distribution information 576 is an update of parameter set 2 distribution 574 information. Parameter set 1 distribution information 572 includes: a mean corresponding to wall loss parameter₁ 512, a variance corresponding to wall parameter₁ 512, a mean corresponding to path loss exponent parameter₁ 514, a variance corresponding to path loss exponent parameter₁ 514, a mean corresponding to diffraction loss parameter₁ 516, and a variance corresponding to diffraction loss parameter₁ 516. Parameter set 2 distribution information 574 includes: a mean corresponding to wall loss parameter₂ 542, a variance corresponding to wall parameter₂ 542, a mean corresponding to path loss exponent parameter₂ 544, a variance corresponding to path loss exponent parameter₂ 544, a mean corresponding to diffraction loss parameter₂ 546, and a variance corresponding to diffraction loss parameter₂ 546. Parameter set 3 distribution information 576 includes: a mean corresponding to wall loss parameter₃ 566, a variance corresponding to wall parameter₃ 566, a mean corresponding to path loss exponent parameter₃ 568, a variance corresponding to path loss exponent parameter₃ 568, a mean corresponding to diffraction loss parameter₃ 570, and a variance corresponding to diffraction loss parameter₃ 570.

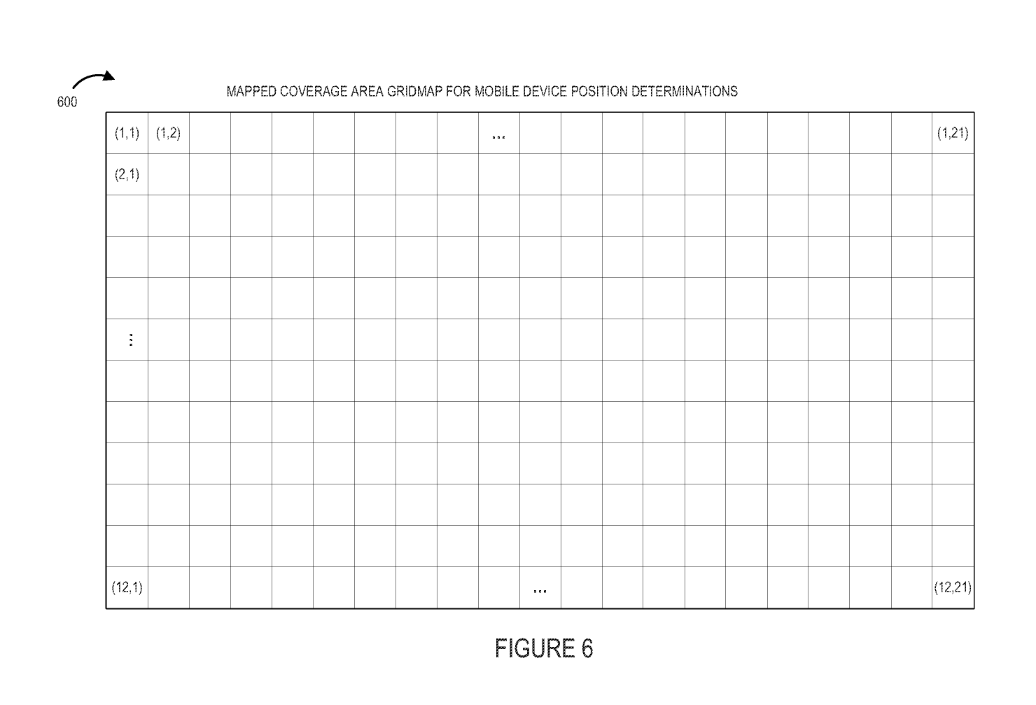

FIGS. 6-10 are used to describe an example of an exemplary method of operating a network device, e.g., a location determination server node, in accordance with an exemplary embodiment. FIG. 6 is a drawing 600 of an exemplary mapped coverage area gridmap for mobile device position determinations stored and used by a network device. In this example, there are 252 indexed location units on the floor plan, and 252 values may be used to represent a signal prediction map corresponding to an access point serving as a location anchor point. In general, there may be N×M location units in the gridmap, where N and M are positive values, and a set of N×M values may be used to represent the gridmap corresponding to an access point serving as a location anchor point, one value in the set corresponding to each unit in the gridmap.

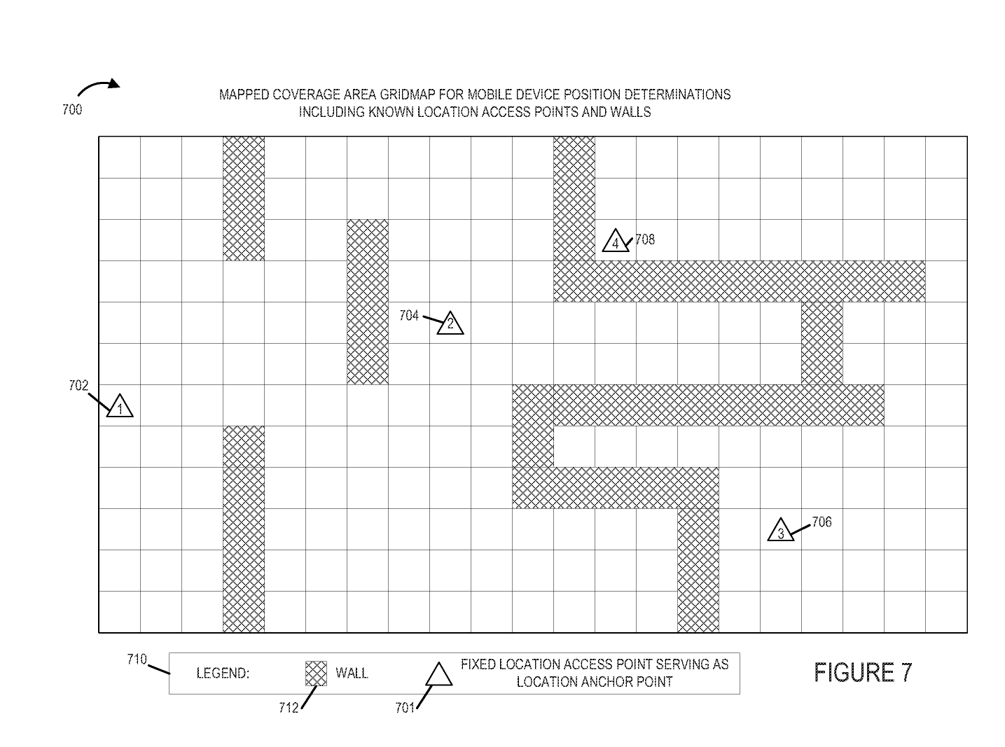

Drawing 700 of FIG. 7 shows exemplary fixed location anchor points serving as location anchor points (access point 1 702, access point 2 704, access point 3 706, access point 4 708) and exemplary walls located on the gridmap of FIG. 6. Legend 710 illustrates that walls are represented by crosshatched shaded boxes 712, while fixed location access points serving as location anchor points are represented by triangle symbols 701. The number inside a triangle is an access point identifier. Information used to represent the coverage area of FIG. 6 and the locations of the access point and the locations of the walls represented in FIG. 7 is stored in the network node, e.g., in the location determination server node, and can be used in combination with a stored set of parameters, e.g., a wall loss parameter, a path loss exponent parameter and a diffraction parameter, to generate signal prediction maps.

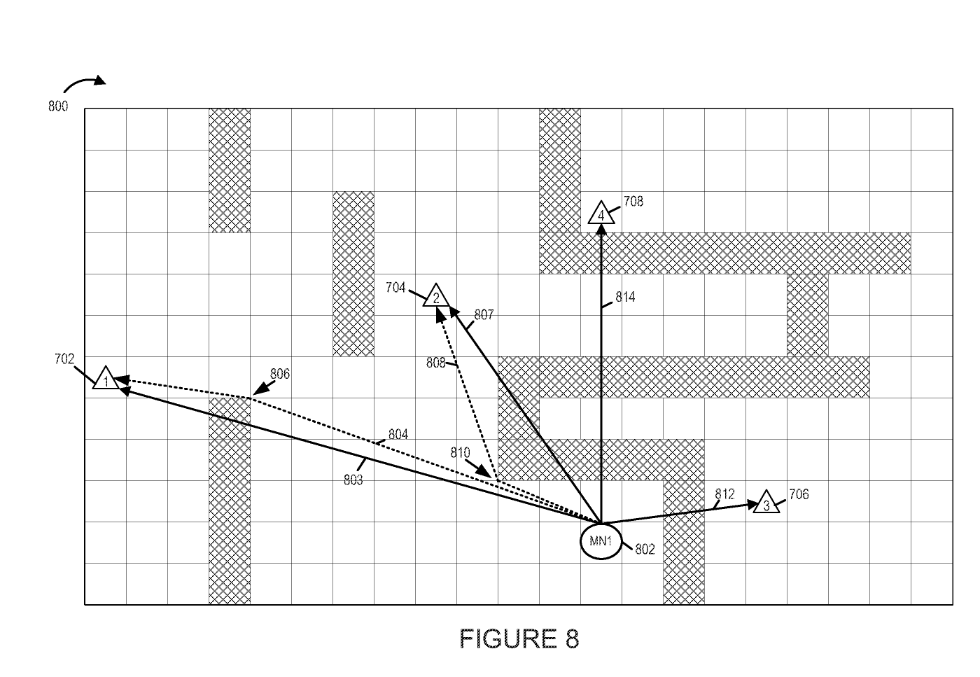

FIG. 8 is a drawing 800 illustrating exemplary signaling and exemplary signal paths from an exemplary mobile node to the access points. In this example, mobile node 1 802 transmits a peer discovery broadcast signal which is detected and measured by the access points (access point 1 702, access point 2 704, access point 3 706, access point 4 708). The direct signal path 803 from mobile node 1 802 to access point 1 702 traverses one wall. The diffraction signal path 804 from mobile node 1 802 to access point 1 702 includes bending at wall corner 806 due to diffraction. The direct signal path 807 from mobile node 1 802 to access point 2 704 traverses two walls. The diffraction signal path 808 from mobile node 1 802 to access point 2 704 includes bending at wall corner 810 due to diffraction. The direct signal path 812 from mobile node 1 802 to access point 3 706 traverses one wall. The direct signal path 814 from mobile node 1 802 to access point 4 708 traverses three walls.

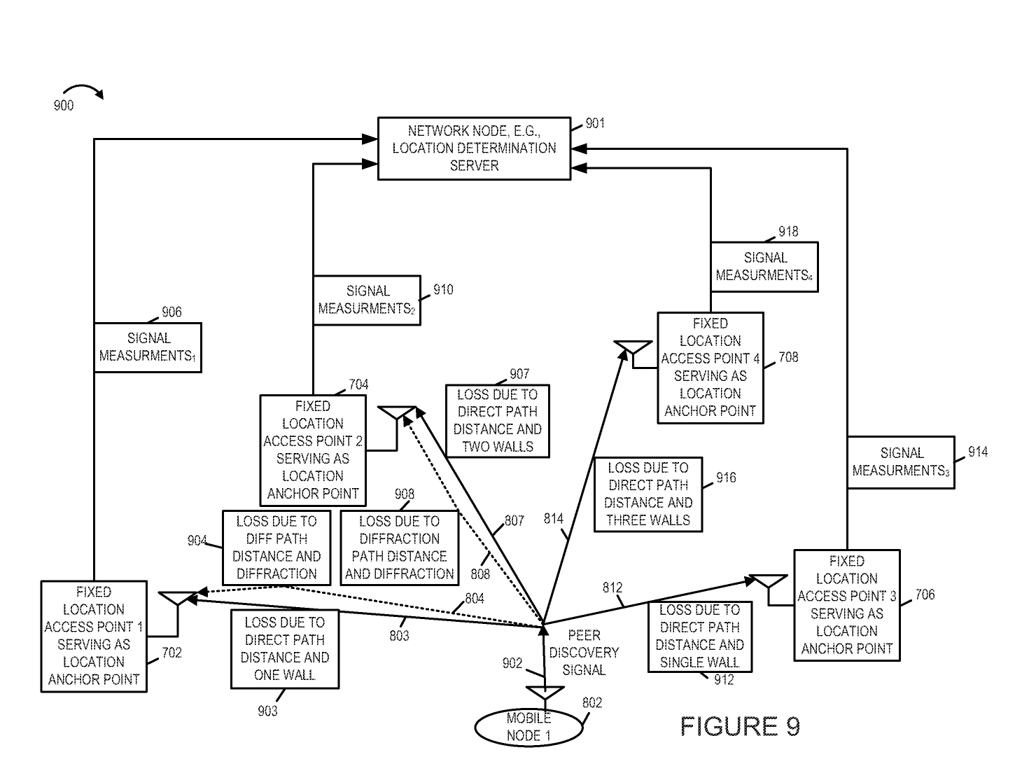

Drawing 902 of FIG. 9 illustrates exemplary signaling, attenuation sources and signal measurements corresponding to the FIG. 8 example. Mobile node 1 802 transmits peer discovery signal 902 at a power level which is known and/or can be determined by the access points (702, 704, 706, 708) and/or by network node 901.

The transmitted peer discovery signal 902 along direct path 803 is attenuated due to the direct signal path distance between mobile node 1 802 and access point 1 702 and by attenuation from passing through a single wall, as indicated by box 903. The transmitted peer discovery signal 902 along the diffraction path 804 is attenuated due to the diffraction path distance between mobile node 1 802 and access point 1 702 and by diffraction, as indicated by box 904. Access point 1 702 receives a composite signal including a direct and diffraction path components and measures the attenuated peer discovery signal determining signal measurements₁ 906. Signal measurements₁ 906 are transmitted to network node 901 via a backhaul network.

The transmitted peer discovery signal 902 along direct path 807 is attenuated due to the direct signal path distance between mobile node 1 802 and access point 2 704 and by attenuation from passing through two walls, as indicated by box 907. The transmitted peer discovery signal 902 along the diffraction path 808 is attenuated due to the signal path distance between mobile node 1 802 and access point 2 704 and by diffraction, as indicated by box 908. Access point 2 704 receives a composite signal including direct and diffraction path components and measures the attenuated peer discovery signal determining signal measurements₂ 910. Signal measurements₂ 910 are transmitted to network node 901 via the backhaul network.

The transmitted peer discovery signal 902 is attenuated due to the direct signal path distance between mobile node 1 802 and access point 3 706 and by attenuation from passing through a single wall, as indicated by box 912. Access point 3 706 receives and measures the attenuated peer discovery signal determining signal measurements₃ 914. Signal measurements₃ 914 are transmitted to network node 901 via the backhaul network.

The transmitted peer discovery signal 902 is attenuated due to the direct signal path distance between mobile node 1 802 and access point 4 708 and by attenuation from passing through three walls, as indicated by box 916. Access point 4 708 receives and measures the attenuated peer discovery signal determining signal measurements₄ 918. Signal measurements₄ 918 are transmitted to network node 901 via the backhaul network.

Network node 901 receives the signal measurements (906, 910, 914, 918) and stores the information to be used subsequently in determining an estimated position of mobile node 1 802.

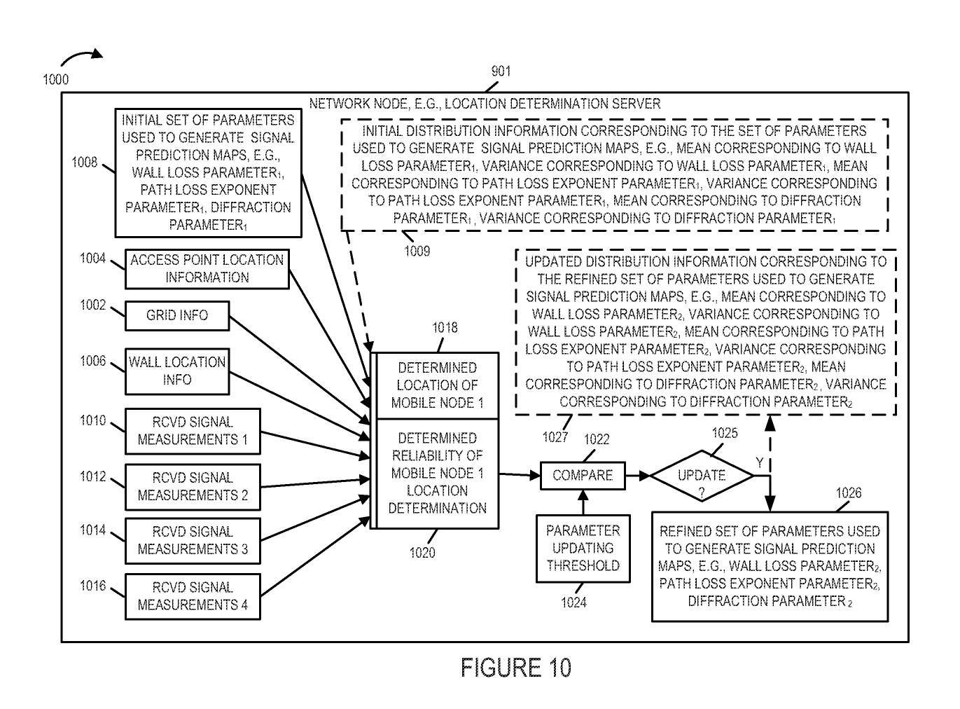

Drawing 1000 of FIG. 10 illustrates exemplary stored information and operations performed by network node 901 in accordance with an exemplary embodiment. Network node 901 uses: stored grid information 1002 representing the map of FIG. 6, stored wall location information 1006 corresponding to FIG. 7, stored access point location information 1004 corresponding to FIG. 7, an initial set of parameters used to generate signal prediction maps 1008, received signal measurements 1 1010, received signal measurements 2 1012, received signal measurements 3 1014, and received signal measurements 4 1016 to determine an estimated location of mobile node 1 1018 and a corresponding determined reliability of the mobile node 1 location determination 1020. Received signals measurements (1010, 1012, 1014, 1016) are received copies of communicated signal measurements (906, 910, 914, 918), respectively.

The network node 901 compares the determined reliability to a parameter updating threshold 1024, as indicated by box 1022. If the determined reliability exceeds the threshold in the comparison 1025, then the network node 901 updates the initial set of parameters 1008 to generate a refined set of parameters used to generate signal prediction maps 1026. In some embodiments, distribution information corresponding to the set of parameters used to generate signal prediction maps is also updated. For example, initial distribution information corresponding to the initial set of parameters used to generate signal prediction maps 1009 is updated to obtain updated distribution information corresponding to the refined set of parameters used to generate signal prediction maps 1027. The refined set of parameters used to generate signal prediction maps is subsequently used by the network node 901 to determine the location of another mobile node, e.g., mobile node 2.

The initial set of parameters used to generate signal prediction maps 1008 is, e.g., wall loss parameter value 1, path loss exponent parameter value 1, and diffraction parameter value 1. The updated set of parameters used to generate signal prediction maps 1026 is, e.g., wall loss parameter value 2, path loss exponent parameter value 2, and diffraction parameter value 2. In some embodiments, values may be, and sometimes are updated on an individual basis, e.g., with different updating threshold being used corresponding to different types of parameters. In some embodiments, there may be, and sometimes are a plurality of wall loss parameters, e.g., corresponding to different types of walls.

The initial distribution information corresponding to the set of parameters used to generate signal prediction maps 1009 includes, e.g., a mean corresponding to wall loss parameter₁, a variance corresponding to wall loss parameter₁, a mean corresponding to path loss exponent parameter₁, a variance corresponding to wall loss parameter₁, a mean corresponding to diffraction parameter₁, and a variance corresponding to diffraction parameter₁. The updated distribution information corresponding to the refined set of parameters used to generate signal prediction maps 1027 includes, e.g., a mean corresponding to wall loss parameter₂, a variance corresponding to wall loss parameter₂, a mean corresponding to path loss exponent parameter₂, a variance corresponding to wall loss parameter₂, a mean corresponding to diffraction parameter₂, and a variance corresponding to diffraction parameter₂.

In the example of FIGS. 6-10, a peer discovery signal transmitted by a mobile wireless device, mobile node 1 802, was measured by access point (702, 704, 706, 710) and the measurements reported back to network node 901 which determined mobile node 1 802 position using signal prediction maps. In some other embodiments, a different type of signal is used in place of or in addition to the peer to peer discovery signal, e.g., a peer to peer pilot signal and/or peer to peer traffic signals. In some embodiments, for at least some locations a different number of access points are used to measure the signal transmitted from a mobile wireless device. In some embodiments, for some locations a single access point is used to measure the signal transmitted from a mobile wireless device. In some embodiments, different portions of the grid covered by the network node correspond to different set of access points.

In some embodiments, the access points serving as location anchor points transmit a signal, e.g., a peer to peer discovery signal and/or a peer to peer pilot signal, which is received and measured by the mobile node. Then, the mobile node reports the measurement information to the network node, e.g., to location determination server node, e.g., via an access point.

In some embodiments, the network node, e.g., a location server node, calculates estimated path loss between a mobile device and an access point serving as a location anchor point as a function of the direct path distance and the diffraction path distance, for different possible positions of the mobile device to generate a set of signal prediction values corresponding to a signal prediction map. In some such embodiments, the estimation includes using: (i) a set of parameters corresponding to the environment, e.g., a wall loss parameter, e.g., Wall_loss_parameter, a path loss exponent parameter, e.g., PLₑₓₚₒₙₑₙₜ, and a diffraction parameter, e.g., Diffraction_loss_parameter, (ii) a floor map, e.g., a grid map corresponding to the coverage area including information identifying the location of the access point serving as a location anchor point, the location of walls, and (iii) information identifying the power at the transmitter of the signal being measured.

In various embodiments, estimation of path loss performed by the network node, e.g., the location determination server node, uses the following equation: PL_{dB} (d_{direct}, d_{diff})=PL_{constant dB}+Direct_Path_Loss_Value_{dB}+Diffraction_Path_Loss_Value_{dB}, where d_{direct} is the direct path distance between the access point serving as a location anchor point and a potential location of the mobile device, where d_{diff} is a diffraction path distance between the access point serving as a location anchor point and a potential location of the mobile device. In some embodiments, the direct path distance is the straight line path distance between the access point serving as a location anchor point and the potential location of the mobile device without consideration of walls. In some embodiments, the diffraction path distance is the shortest path between the access point serving as a location anchor point and the potential location of the mobile device, in which the diffraction path avoids walls. In various embodiments, the network node calculates the direct path distance and diffraction path distances using the stored map information.

In some embodiments, PL_{constantdB}=20 log₁₀ (Friis constant). In some such embodiments, the Friis constant=4πfc/1 MHz, where fc is the frequency of the signal being measured.

In various embodiments, Direct_Path_Loss_Value_{dB}=(Wall_loss_paramter)(Num_walls_on_direct_path)+10(PLₑₓₚₒₙₑₙₜ)(log₁₀(d_{direct}))₅ where Num_walls_on direct_path is the number of walls a direct path signal would have to traverse on the direct path between the access point serving as a location anchor point and the potential mobile node location based on the topology in the stored map information.

In various embodiments, Diffraction_Loss_Value_{dB}=(Diffraction_loss_paramter)(Num_edges_on_shortestpath_thatavoidsallwalls)+10(PLₑₓₚₒₙₑₙₜ)(log₁₀(d_{diff})), where Num_edges_on_shortestpath_thatavoidsallwalls is the number of corners that a diffraction signal would bend around on the diffraction path between the access point serving as a location anchor point and the potential mobile node location based on the topology in the stored map information.

In some embodiments, the wall loss parameter is with the approximate range of 3 to 6 dBs. In some embodiments, the path loss exponent parameter is with the approximate range of 1.8 to 2.2 dBs. In some embodiments, the diffraction path parameter is with the approximate range of 10 to 13 dBs. In one exemplary embodiment a floor map grid is, e.g., 34×70 meters with resolution to 1 meter.

In various embodiments, the set of parameters used to generate signal prediction maps, e.g., the wall loss parameter, the path loss exponent parameter, and the diffraction path parameter, are successively refined by the network node, e.g., the location determination server node, e.g., in accordance with the method of flowchart 200 of FIG. 2.

In some embodiments, as part of generating an updated set of parameters, the network node, e.g., the location determination server node determines a set of parameters that minimizes a function. For example, the network node determines that the best parameters=argmin₃ₚₐᵣₐₘₜₑᵣₛ|Meas−(TX_{power}−PL_{dB}(d_{direct}, d_{diff}))|̂2, where Meas=the measured power of the transmitted signal being measured and TXpower=the transmission power of the signal being measured.

In some embodiments including measurements by multiple access points corresponding to the same signal transmitted by a mobile device, an updated set of parameters is calculated based on readings from multiple access points. For example, the network node determines that the best parameters=argmin₃ₚₐᵣₐₘₜₑᵣₛ∥Meas−(TX_{power}−PL_{dB}(d_{direct}, d_{diff}))∥̂2, where Meas=a vector of the measured power of the transmitted signal being measured corresponding to the multiple access points and TXpower=a vector of the transmission power of the signal being measured, and PL_{dB} (d_{direct}, d_{diff}) is a vector the path loss value corresponding to the multiple access points.

In some embodiments, the diffraction calculations include adjustments due to reflections and/or waveguide losses. In some embodiments, a plurality of wall loss parameter values are used corresponding to different types of walls, e.g., different materials, different wall thickness, etc.

In some embodiments, statistics of the parameters are estimated. For instance, the mean, variance and/or a distribution function of each parameter is estimated based on the signal measurements and the determined position of the mobile. In some embodiments, the parameters may be modeled as having a prior distribution, for example a Gaussian distribution with a nominal mean and a nominal variance or a uniform distribution with a nominal mean and a nominal variance. Based on the measurements, the determined position of the mobile, and the prior distribution on the parameters, the parameter and the statistics of the parameters, such as, e.g., the mean, variance and/or a distribution function, may be estimated. The prior distribution on the parameters may be updated with the newly estimated statistics. The resulting distribution, in turn, can be used in the next parameter estimation iteration to again estimate the parameter values and parameter statistics given a fresh set of measurements.

In various embodiments, network node 901 of FIG. 9 is network node 300 of FIG. 3 and/or implements a method in accordance with flowchart 200 of FIG. 2.

Various aspects of some embodiments relate to a centralized learning of the parameters of a parametric model underlying a fingerprint map. In some embodiments, the learning happens at a network device which receives signals from mobile devices and measures their fingerprints. In some embodiments, the received signals are peer discovery signals or traffic signals that are normally transmitted by the mobiles. In some embodiments, the received signals are dedicated positioning signals. In some situations a positioning system may have sufficient redundancy so that a network device can determine the position of a mobile device to a certain high level of reliability without the determination necessarily depending on each of the available fingerprint measurements. In some embodiments, in such a case the network device can independently sample those measurements that were not useful for position determination, by virtue of being significantly different, in value, than the predictions, so as to gather information that can be used to improve the accuracy of the fingerprint map(s). In particular, the network device may, and sometimes does, infer information about one or more parameters used in a fingerprinting map. In one embodiment, the network device may, and sometimes does, accomplishes this inference by using a discrete ray-tracing method. For example, by tracing a radio wave's path from the determined position to itself or another network anchor point, the method can determine the relationship between the fingerprint at that position and the wall parameters, e.g., reflection loss parameter, refraction loss parameter, diffraction loss parameter, of the walls relevant for that path. The redundant measurements previously sampled can then be used to solve the inverse problem: given the measured fingerprints and the determined relationship between fingerprints and parameters, find the parameters that fit those measurements. In another embodiment, the network device may, and sometimes does, randomly or deterministically adjust a subset of the parameters of the fingerprint map in an attempt to minimize the difference between the resulting fingerprint predictions and the sampled measurements.

In another embodiment, the network may also use fingerprint data that have been recorded by the network device and originating in other devices, e.g. mobile devices and/or network devices, for the same purpose. In some such embodiments, the updated parameter values are used in a parametric model to generate an updated fingerprint prediction map. The new fingerprint prediction maps are then used in positioning the same and/or other mobile devices.

In various embodiments positioning and parameter/map updating is performed by a network node, e.g., a location determination server node, instead of the individual mobiles. In various embodiments a network node, e.g., a location determination server node, uses the parameter updates computed based on fingerprint measurements of one mobile device to compute the position of another mobile.

In various embodiments a device, e.g., network device 300 of FIG. 3 includes a module corresponding to each of the individual steps and/or operations described with regard to any of the Figures in the present application and/or described in the detailed description of the present applications. The modules may, and sometimes are implemented in hardware. In other embodiments, the modules may, and sometimes are, implemented as software modules including processor executable instructions which when executed by the processor of the communications device cause the device to implement the corresponding step or operation. In still other embodiments, some or all of the modules are implemented as a combination of hardware and software.

The techniques of various embodiments may be implemented using software, hardware and/or a combination of software and hardware. Various embodiments are directed to apparatus, e.g., network nodes such as location determination server nodes, mobile nodes such as mobile terminals, access points such as base stations serving as location anchor points, and/or communications systems. Various embodiments are also directed to methods, e.g., method of controlling and/or operating network nodes, mobile nodes, access points such as base stations and/or communications systems, e.g., hosts. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal processing, signal generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more methods of the invention.

In some embodiments, the processor or processors, e.g., CPUs, of one or more devices, e.g., communications nodes such as network nodes, access nodes and/or wireless terminals, are configured to perform the steps of the methods described as being performed by the communications nodes. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a device, e.g., communications node, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer to peer signaling protocol. Various embodiments are well suited to location determination in indoor environments.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating a network device, the method comprising:
receiving signal measurements corresponding to a first mobile wireless device;
determining a position of the first mobile wireless device from the received signal measurement information;
updating a set of parameters used to generate a signal prediction map based on the signal measurements corresponding to the first mobile wireless device and the determined position of the first mobile wireless device; and
generating a new signal prediction map based on the updated set of parameters.

2. The method of claim 1, wherein said network device is a location determination server.

3. The method of claim 1, further comprising:
prior to updating a set of parameters, determining that said determined position was determined with a reliability exceeding a threshold used to control updating of said set of parameters.

4. The method of claim 3, wherein said signal measurements are measurements made by said first mobile wireless device and communicated to said network device.

5. The method of claim 3, wherein said signal measurements are measurements of a signal transmitted by the first mobile wireless device which is measured by at least one access node or a second mobile wireless device.

6. A network device, comprising:
means for receiving signal measurements corresponding to a first mobile wireless device;
means for determining a position of the first mobile wireless device from the received signal measurement information;
means for updating a set of parameters used to generate a signal prediction map based on the signal measurements corresponding to the first mobile wireless device and the determined position of the first mobile wireless device; and
means for generating a new signal prediction map based on the updated set of parameters.

7. The network device of claim 6, wherein said network device is a location determination server.

8. The network device of claim 6, further comprising:
means for determining if said determined position was determined with a reliability exceeding a threshold used to control updating of said set of parameters.

9. The network device of claim 8, wherein said signal measurements are measurements made by said first mobile wireless device and communicated to said network device.

10. The network device of claim 8, wherein said signal measurements are measurements of a signal transmitted by the first mobile wireless device which is measured by at least one access node or a second mobile wireless device.

11. A computer program product for use in a network device, the computer program product comprising:
a non-transitory computer readable medium comprising:
code for causing at least one computer to receive signal measurements corresponding to a first mobile wireless device;
code for causing said at least one computer to determine a position of the first mobile wireless device from the received signal measurement information;
code for causing said at least one computer to update a set of parameters used to generate a signal prediction map based on the signal measurements corresponding to the first mobile wireless device and the determined position of the first mobile wireless device; and
code for causing said at least one computer to generate a new signal prediction map based on the updated set of parameters.

12. The computer program product of claim 11, wherein said network device is a location determination server.

13. The computer program product of claim 11, wherein said non-transitory computer readable medium further comprises:
code for causing said at least one computer to determine whether said determined position was determined with a reliability exceeding a threshold used to control updating of said set of parameters, prior to updating a set of parameters.

14. The computer program product of claim 13, wherein said signal measurements are measurements made by said first mobile wireless device and communicated to said network device.

15. The computer program product of claim 13, wherein said signal measurements are measurements of a signal transmitted by the first mobile wireless device which is measured by at least one access node or a second mobile wireless device.

16. A network device comprising:
at least one processor configured to:
receive signal measurements corresponding to a first mobile wireless device;
determine a position of the first mobile wireless device from the received signal measurement information;
update a set of parameters used to generate a signal prediction map based on the signal measurements corresponding to the first mobile wireless device and the determined position of the first mobile wireless device; and
generate a new signal prediction map based on the updated set of parameters; and
memory coupled to said at least one processor.

17. The network device of claim 16, wherein said network device is a location determination server.

18. The network device of claim 16, wherein said at least one processor is further configured to:
determine if said determined position was determined with a reliability exceeding a threshold used to control updating of said set of parameters.

19. The network device of claim 18, wherein said signal measurements are measurements made by said first mobile wireless device and communicated to said network device.

20. The network device of claim 18, wherein said signal measurements are measurements of a signal transmitted by the first mobile wireless device which is measured by at least one access node or a second mobile wireless device.
